(19) United States
(12) Patent Application Publication
(10) Pub. No.: US 2012/0118995 A1
(43) Pub. Date: May 17, 2012

(54) Safety video spray

(76) Inventors: Tselane Robertson, Herndon, VA (US); Charlie Robertson, II, Philadelphia, PA (US)

(21) Appl. No.: 13/373,298

(22) Filed: Nov. 10, 2011

Related U.S. Application Data
(60) Provisional application No. 61/412,605, filed on Nov. 11, 2010.

(51) Int. Cl. B05B 15/00

(52) U.S. Cl. 239/289

(57) ABSTRACT

A personal protection device providing the user with increased protection against an attacker. The device is sufficiently compact so that it can be hand-held by the user. The device is equipped with a canister containing pepper spray (or other non-lethal fluid), a camera (capable of recording up to three minutes), and a USB post which allows for recorded material to be downloaded to a personal computer. The design of the device is such that the user's ability to use the device easily, efficiently, and effectively is maximized. Furthermore, the design allows for an attack to be recorded and stored so that images of the attack can be subsequently produced. These images can then be used by law enforcement to identify the attacker and help lead to his/her capture.

### CROSS-REFERENCE TO RELATED APPLICATIONS

This invention claims priority, pursuant to 35 U.S.C. §120, to the U.S. Provisional Patent Application No. 61/412,605 filed on Nov. 11, 2010, which is incorporated by reference herein.

### FIELD OF THE INVENTION

This invention relates generally to hand-held personal protection systems and devices, and specifically to systems and devices incorporating video cameras and non-lethal fluids.

### BACKGROUND OF THE INVENTION

The unfortunate reality of today's society is that some people are victims of violent crime. As a result, many people feel the need to arm themselves with some type of protection. While lethal personal protective devices (e.g., hand guns) may be effective, their use may also be illegal. In addition, use of such devices may cause unintended consequences, (e.g., death).

Conventional personal protection devices also lack the capability to allow the user to help law enforcement identify the attacker subsequent to the attack. Such short-comings have the obvious disadvantage of potentially allowing the perpetrators of an attack to evade justice.

A search of the prior art shows that there a numerous patents relating to personal protection devices. U. S. Patent Application Publication No. 2007/0194048 filed by TEIG discloses a personal defense device. The device provides illumination and chemical spray protection. The device comprises a housing, a fluid canister, an actuator in communication with the fluid canister and is configured to release fluid, and a spray nozzle. The device can be equipped with a light system and/or camera.

U.S. Pat. No. 7,221,552 issued to Brown discloses a personal defense device. The device comprises a shield and an electric shock device. The personal defense device is configured to be worn by a user. It can be equipped with a guantlet-style glove attached to the shield and electric shock device. The electric shock device delivers non-lethal electrical shock and/or sparks to defend against an attacker.

U.S. Patent Application Publication No. 2006/0201964 filed by DiPerna et al. discloses a personal protection device which can be integrated with a moblie device. The personal protection device comprises a camera, a locator, a transmitter, a self-defense mechanism (which may contain pepper spray), and a panic button.

These documents disclose various types of devices that provide some form of personal protection. However, none of these devices provide the user with adequate protection. For example, the device of DiPerna is integrated with another devive (e.g., mobile phone). In the event of an attack, a user would have a difficult time properly positioning the device. In addition, because the device has so many functions, the user would not be able to quickly identify the “self-protection” functions. The device of Brown is to be worn, it is not hand-held. Furthermore, it is so large it cannot be conveniently stored in a purse, pocket, etc. or otherwise concealed. Also, it was design for use by law enforcement, military personnel, etc. It was not designed for use by the public. The device of TEIG discloses a spray nozzle located very close to a camera lens. This is problematic in that a discharged fluid from the nozzle may land on the camera lens. Furthermore, the actuation of the nozzle and the camera are simultaneous or essentially simultaneous. However, there may be times when the user may find it useful to only video tape an interaction without discharging the non-lethal fluid.

Consequently, there is a need for a personal protection device that fits comfortably in the user's hand, that will be of sufficient size and shape to be easily carried and concealed on the user's person, and that can be easily, efficiently, and effectively used while the user is under attack. Such a device should also provide non-lethal fluid directed at the attacker and is equipped with a video camera that can record the attack, with such recording downloadsable to a personel computer via a USB port, thereby providing subsequent assistance to law enforcement (e.g., in identifying the assailant). A search of the prior art shows that no such personal protection device is known.

### SUMMARY OF THE INVENTION

It is a primary objective of the present invention to provide a personal protection device that can be used by a user to ward off an attacker. More particularly, it is an objective of the present invention to provide a personal protection device wherein the means of warding off an attacker are non-lethal.

It is another objective of the present invention to provide a personal protection device that has video taping capabilities (of up to three minutes) in order to record an attack. Video taping may be accomplished by utilizing a camera. The videotaped footage is stored in any of the mediums known in the art. In a non-limiting example, the camera is similar to those currently available in cell phones and other personal digital assistants.

It is still another objective of the present invention to provide a personal protection device that is compact enough to fit into a user's hand.

It is a further objective of the present invention to provide a personal protection device that can be connected to a computer in order to download a recorded attack.

The personal protection device is comprised of a housing. The housing has a cavity in which a canister is maintained. The canister is pressurized and has a non-lethal fluid (e.g., pepper spray). The cavity can be accessed by opening a door located on the front of the housing. The personal protection device also has a spray head. Within the spray head is a nozzle. When a canister is within the housing of the personal protection device, it is connected to the spray head nozzle. The personal protection device also comprises a camera. The camera is located at the bottom of the personal protection device. The lens of the camera is located on the front of the device, at the bottom. The camera is powered by a small (e.g., watch-sized) battery. The personal protection device also comprises a USB port which can be connected to a computer. The USB port is located on the back of the personal protection device, at the bottom. When the spray head is depressed once, the camera is activated. When the spray head is depressed a second time, the non-lethal fluid is discharged.

### BRIEF DESCRIPTION OF THE DRAWINGS

Preferred and alternative embodiments of the present invention are described in detail below with reference to the following drawings:

FIG. 1 is an angled front view of a personal protection device.

FIG. 2 is an angled front view of a personal protection device with the door open and the cannister located outside of the device.

FIG. 3 is an angled rear view of the personal protection device of FIG. 1.

### DETAILED DESCRIPTION OF THE PREFERRED EMBODIMENT

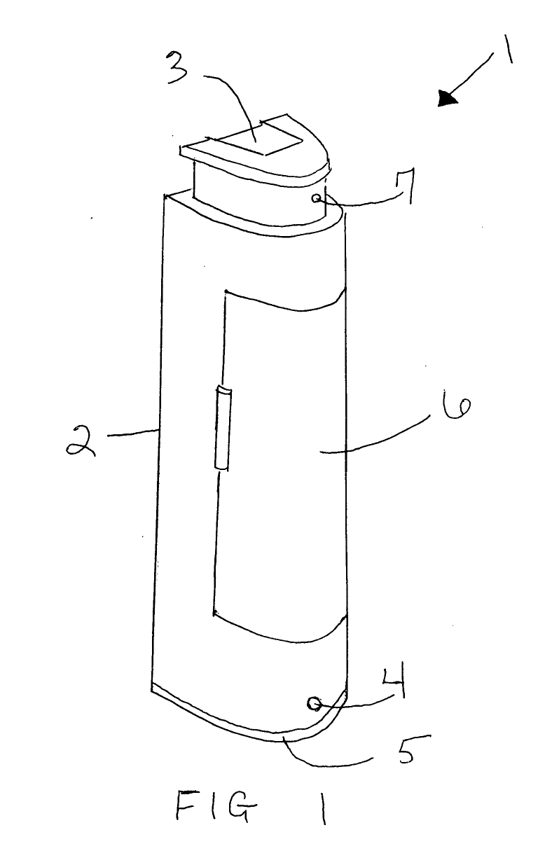

Referring to FIG. 1, a personal protection device 1 is comprised of a housing 2, a spray head 3, a camera lens 4, a battery compartment 5, a door 6, and a nozzle 7. In a first preferred embodiment, the personal protection device 1 is constructed of a durable plastic. However, the personal protection device 1 may be constructed of any known light-weight durable material. The housing 2 is semi-tubular in shape and is compact enough to be held in the hand of a user. The front of the housing 2 is curved and the back of the housing 2 is flat. As can be seen, the spray head 3 is horse shoe/arrow head shaped. The front of the spray head 3 is curved and the back of the spray head 3 is flat. The shaping of the housing 2 and the spray head 3 is important in that the shaping assists the user in properly positioning the personal protection device before activation. The top of the spray head 3 is wide and flat. Such shaping allows for easy depression (i.e., activation) by the user. In a situation whereby the user is being attacked, the pressure is high and time is of the essence. In addition, a lot of quick movement is probably required by the user (to fend off the attack). Under such circumstances, it is common for a user to erroneously operate such a device, thereby minimizing the device's effectiveness. In some cases, the user may accidentally spray themselves. The shaping of the present invention is critical in that it allows a user to quickly, and correctly, utilize the device.

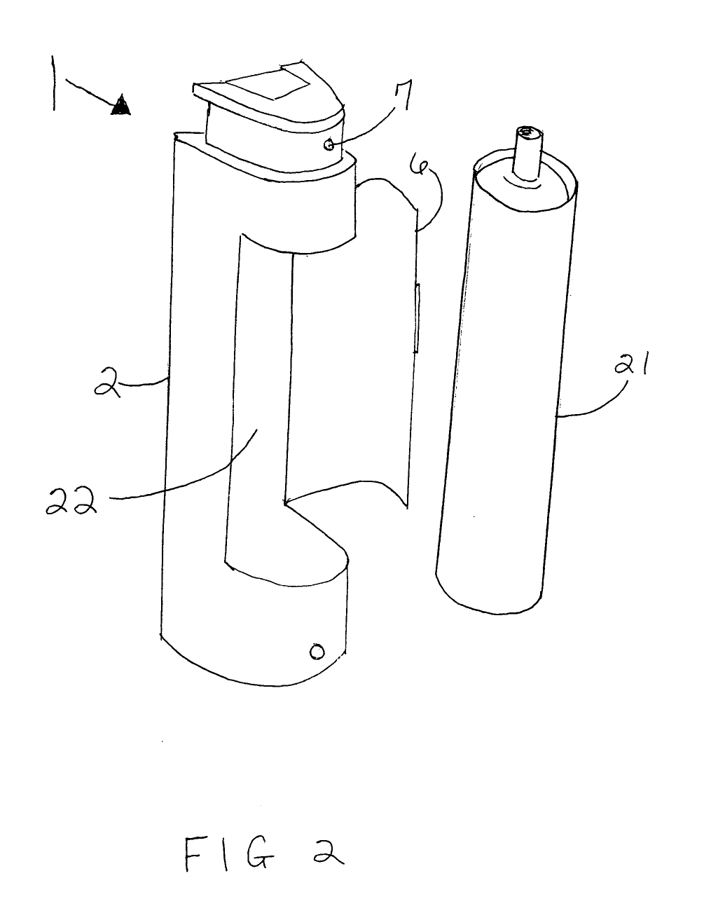

Referring to FIG. 2, the housing 2 has a door 6 that swings open by use of hinges or other known means. A canister 21 can be secured within the cavity 22 of the housing 2. Once placed inside of the cavity 22, the canister is attached to the nozzle 7.

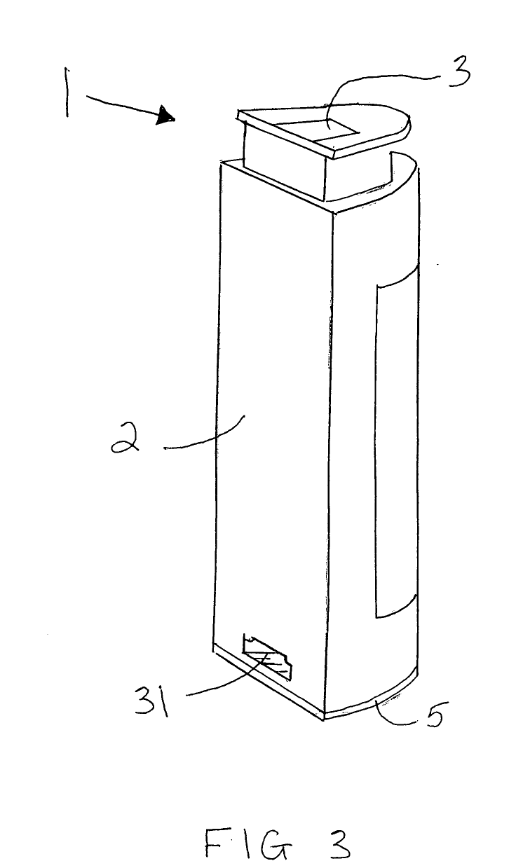

As is shown in FIG. 3, the back of the housing 2 and the back of the spray head 3 are both flat. A USB port 31 is located on the back of the housing 2, at the bottom. When the USB port 31 is connected to a personal computer, images of an attack (previously recorded by the video camera) can be produced. These images can be appropriately manipulated (e.g., printed, transferred, etc) thereby assisting law enforcement in identifying the attacker and hopefully leading to his/her capture.

While the preferred embodiment of the invention has been described, various alternative embodiments of the invention are possible without departing from the spirit and scope of the invention. For example, the personal protection device may be constructed of any light-weight material. Also, although the preferred embodiment discloses a cannister containing pepper spray, the cannister may contain any non-lethal fluid. Accordingly, the scope of the invention is not limited by the disclosure of the preferred embodiment.

What is claimed is:

1. A personal protective device comprising:
a longitudinal axis;
a semi-tubular housing defining a cavity;
a door releasably attached to the front of the housing;
a canister;
a spray head located at the top of the housing and oriented in a direction that is substantially perpendicular to the longitudinal axis of the housing;
a video camera;
wherein the video camera is powered by a battery.

2. The personal protective device of claim 1, wherein the spray head comprises a button and a nozzle.

3. The personal protective device of claim 2, wherein the canister is releasably attached to the nozzle within the housing.

4. The personal protective device of claim 3, further comprising a USB port that is located at the bottom of the housing

5. The personal protection device of claim 4, wherein the video camera is located in the bottom of the housing.

6. The personal protective device of claim 5, wherein the USB port is located on the back of the housing.

7. The personal protective device of claim 6, wherein the personal protective device is constructed of plastic.

8. The personal protective device of claim 7, wherein the spray head is shaped like a rounded arrowhead./horse shoe

9. The personal protective device of claim 8, wherein the battery that powers the video camera is circular, thin, and flat.

10. The personal protective device of claim 9, wherein the video camera has a lens located on the front of the housing.

11. The personal protective device of claim 10, wherein the video camera is capable of recording for up to three minutes.

12. The personal protective device of claim 11, wherein the button is depressed once to activate the video camera.

13. The personal protective device of claim 12, wherein the button is depressed twice to activate the spray.

14. The personal protective device of claim 8, wherein the personal protective device is compact enough to be held in a user's hand.

15. A personal protective device comprising:
a semi-tubular housing defining a cavity and having longitudinal axis;
a spray head comprising a button and a nozzle, with the spray head positioned on top of the housing and the nozzle directed in the same direction as the front of the housing;
a door releasably attached to the front of the housing, thereby providing access to the cavity within the housing;
a pressurized canister, containing a non-lethal fluid, maintained within the cavity of the housing and releasably coupled to the nozzle;
a video camera, comprising a lens, battery, and storage means, located within the cavity of the housing, at the bottom of the housing, with the lens directed in the same direction as the front of the housing and the nozzle; and
a USB port located in the back of the housing, at the bottom, thereby providing communication means with a personal computer;
wherein the battery is small and flat and is maintained in a compartment located in the bottom of the housing under the lens.

16. The personal protective device of claim 15, wherein the spray head is shaped like a rounded arrowhead/horse shoe.

17. The personal protective device of claim 16, wherein the housing is constructed of a lightweight, durable material.

18. The personal protective device of claim 17, wherein the housing is constructed of plastic.

19. The personal protective device of claim 18, wherein the spray head is depressed once to activate the video camera and is depressed a second time to activate the nozzle and discharge the non-lethal fluid.

20. The personal protective device of claim 19, wherein the video camera is capable of recording and storing up to three minutes of footage.
